(19) United States
(12) Patent Application Publication
(10) Pub. No.: US 2014/0053250 A1
(43) Pub. Date: Feb. 20, 2014

(54) Access to Web Application via a Mobile Computing Device

(71) Applicant: University of Utah Research Foundation, (US)

(72) Inventors: Kevin Lee Wethington, Salt Lake City, UT (US); Craig Richard Swapp, Murray, UT (US)

(73) Assignee: UNIVERSITY OF UTAH RESEARCH FOUNDATION, Salt Lake City, UT (US)

(21) Appl. No.: 13/764,713

(22) Filed: Feb. 11, 2013

Related U.S. Application Data
(60) Provisional application No. 61/597,427, filed on Feb. 10, 2012.

(51) Int. Cl. H04L 29/06

(52) U.S. Cl. CPC H04L 63/10
USPC 726/5

(57) ABSTRACT

Technology is described for allowing access to a web application using a mobile computing device. The method can include obtaining a secure user identifier associated with the mobile computing device as confirmed by a secure wireless network. A hardware device identifier can be retrieved from the mobile computing device. Physical location coordinates can be identified for the mobile computing device. The user identification, hardware device identifier and the physical location can be sent to a web server. Another operation can be enabling access to the web application based on the secure user identifier, a hardware device identifier and correct physical location coordinates as defined by the web application.

### BACKGROUND

In the electronic landscape, securing sensitive information can be challenging. Computer security is a constant problem for software and computing devices that use the Internet and other networked electronic communication channels. A common type of security for networks and web applications is to allow a user to submit a username and password to authenticate the user's identity to the network and/or web application. This generally provides a low level of security for users, unless highly complex login names and passwords are used. Even then, brute force or other types of hacking attacks may be used to break into a system using a login name and password.

The use of a username and password or similar schemes also places a burden on the users to remember the user name and password for the application or website desired to be accessed. In today's networked, multi-application environments, the number of user names and passwords that users may accumulate is dramatically increasing. As the number of networks, web applications, and software applications that users are able access is steadily increasing, this can pose a large burden on users to remember the multitude of login names and passwords that the user may have. In some situations, a user may have to even provide multiple logins (e.g., two or three usernames and passwords) just to enter a single existing software application due to the layers of security that may be in place.

### BRIEF DESCRIPTION OF THE DRAWINGS

FIG. 1 is a block diagram illustrating an example system for allowing access to electronic information via a mobile computing device having wireless communication capability.

FIG. 2 is a flowchart illustrating an example method for allowing access to a web application using a mobile computing device.

FIG. 3 is an example of a Venn diagram illustrating data sets that can be used for mobile computer device security.

FIG. 4 is a flowchart illustrating an example of a method for providing web application security.

FIG. 5 is a flow chart illustrating an example of a method for web server application validation.

FIG. 6 is flowchart illustrating an example of a method for web server authentication.

### DETAILED DESCRIPTION

Reference will now be made to the examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

Mobile computing devices are generally a customized single user environment. This is particularly true of cell phones or smart phones. Because of the nature of cell phones, each cell phone is typically used by just a single user. Cell phone users are not likely to allow other people to use their personal cell phone or personal computing tablet, especially in a workplace setting. In a family setting, most cell phone users have their own cell phone handset. Even when a cell phone is loaned to another family member this cell phone will not be used at the cell phone owner's place of work. For example, a child may borrow a parent's phone but the cell phone would not be used at the parent's work location. In this sense, a professional person's wireless device (e.g., cell phone, tablet, or similar device) may be relied on to identify them when the professional is in their workplace.

The present technology provides the ability for computer software applications and web applications (sometimes called “apps”) executing on the mobile devices to be selective about the physical locality that the applications will run in. If a business has created an application that is specific to just that business, then the business may want to ensure that the application is limited to executing when a registered device (wireless or wired) is at the location of the business as defined by specific geographic coordinates. This type of geo-locational security can provide an additional level of security and/or privacy to the applications used by a business. For example, an application may be allowed to run when the application is located within certain geographically defined boundaries (e.g., longitude and latitude) and/or other secure identifiers are provided.

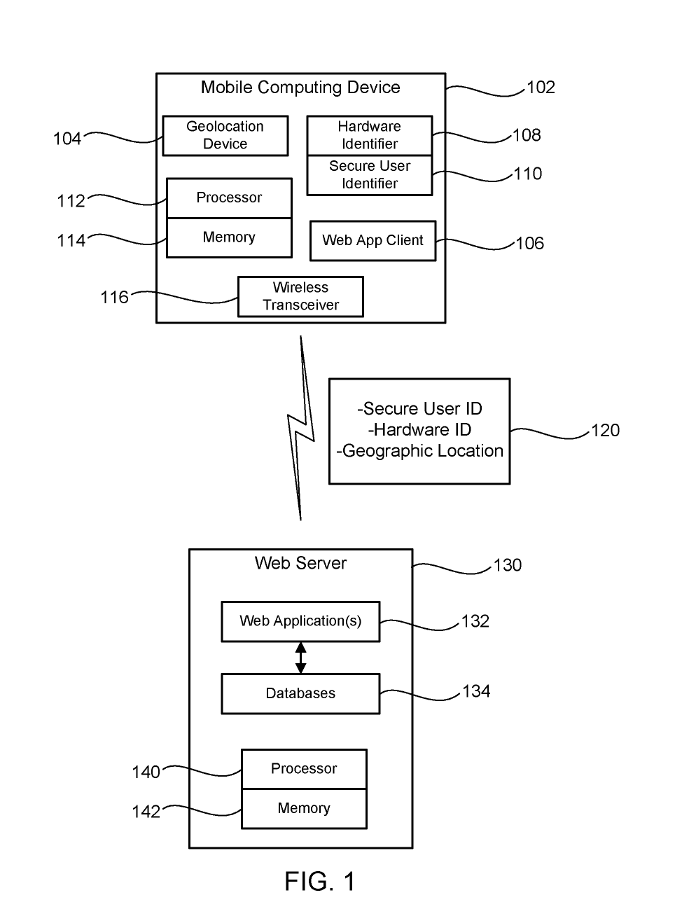

FIG. 1 illustrates a system for allowing access to electronic information via a wireless or wired network. The system can include a mobile computing device 102 having wireless communication capability. The mobile computing device can include a hardware identifier 108, and a secure user identifier 110. A processor 112, memory 114, and wireless transceiver may also be located in the mobile computing device.

The secure user identifier 110 may be a collection of one or more unique identifiers that may be available from a device. Secure user identifiers 110 may include, but are not limited to, a cell phone number, MAC address of a wireless chipset, MEID, UDID, future device identifiers, and other device identifiers. In one example configuration, a cell phone number that is used by one specific mobile computing device may be used as a secure user identifier 110. The cell phone number may be obtained by using an API provided by the operating system of the mobile computing device. The cell phone number can be securely confirmed by: 1) an internal application source such as a database, 2) an irrefutable source on the phone itself, 3) an external source like a database or vendor reference, and/or 4) pinging the nearest cell tower to securely verify that a phone number is assigned to that device alone. Another secure user identifier may be a vendor account ID that is used with just that particular device (e.g., cell phone account identifier or a cable box device ID).

A wireless geolocation device 104 in the mobile computing device can be provided to capture a geographic location of the mobile computing device. The geolocation device can use satellite navigation equipment (e.g., GPS), wireless cell phone signals or other geolocation systems.

A web application client 106 or similar “app” can reside on the mobile computing device. The web application client 106 can send the secure user identifier, the hardware identifier and the geographic location 120 to a web application 132 to validate transaction requests with the web application. This transmission can take place over a wireless network such as a cellular network, a Wi-Fi network or even a wired network.

The software for the web application client can be compiled into the one or more application(s) loaded on a cell phone, tablet device or other computing device. Each time a web application is invoked or a transaction takes place, the web application may use the HTTP (Hypertext Transfer Protocol) to communicate the mobile computing device's location to a web application 132 and obtain permission to run. Of course, other internet enabled protocols could also be used for sending the device's location such as FTP, Telnet, Remote Procedure Calls, SNMP, etc.

The web server 130 can use the information 120 submitted to the web application 132 to look up the current security access status of the application and device requesting access, when the web application receives a request from the device and the web client. The lookup can be performed by accessing a database, Active Directory network directory service, MS SQL server, Oracle database server, etc. and the information received from the lookup can affirm that the app has permission to run based on the device's physical location and/or additional credentials.

The software code for the web application client can be encapsulated in an API for use by other standalone applications. This may be a software library contained in a .jar or .dll, or .obj library and the library can be linked into an executable or pseudo code interpreted at run-time. This allows multiple web applications to re-use the authentication system described by this technology.

The web server 130 can be provided to host the web application(s) 132 in communication with the web application client. A database 134 can be located on the web server 130, and the database can be in communication with the web application. The database can be configured to transmit data or provide query results for the web application after the web application has validated the correct secure user identifier, hardware identifier and geographic location received from the web application client. The database can be a relational database, object oriented database, a flat file database or another database system. The web server can include a processor 140 and memory 142 to execute the web applications and databases.

In some cases, before the authentication for each web application transaction takes place, the initial ‘registration’ of the device and application can request a username and password be supplied in order to: identify the user, certify the user is qualified to run the app on the mobile device, and register the device with the authentication system and/or directory services for a local network. Once the user is recognized and the usage of the app is certified, the web application may be configured not to ask for the username or password again or just request the login information infrequently. This technology can use a combination of information to authenticate the web applications on the device and since that information that is difficult to obtain without possessing the mobile computing device, the ability of hackers and crackers to access the system is reduced.

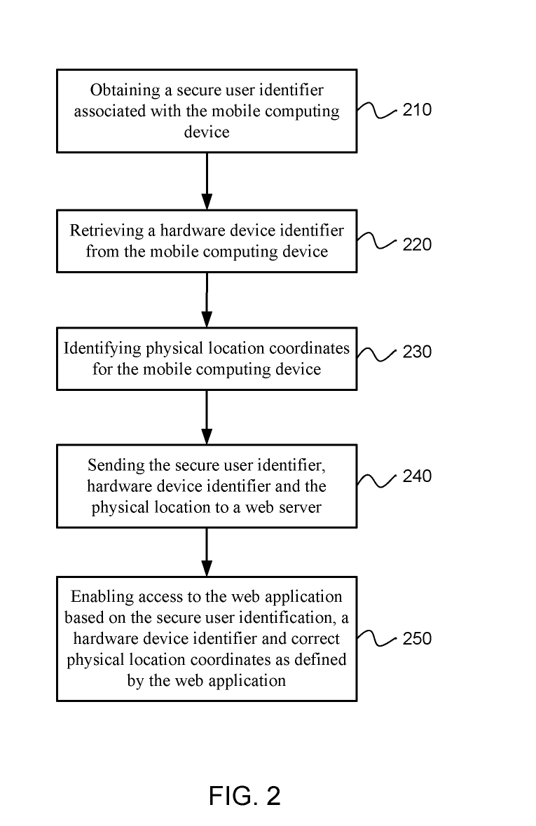

FIG. 2 is an example flowchart illustrating a method for allowing access to a web application using a mobile computing device. Before the method described below can be used, an initial enrollment can take place where a user is enrolled into the application and system hosting the web application. This enrollment can include the user providing a user name and password to the web application to enroll the wirelessly enabled device or mobile computing device into the web application environment.

The method can then include the operation of obtaining a secure user identifier associated with the mobile computing device as confirmed by a secure wireless network, as in block 210. The secure user identifier can be a user's cell phone number, where the user is authorized to use the single mobile device and cell phone number on the carrier's cell phone network. The web application can verify that the user's cell phone number is unique and the specific handset using the cell phone number is the one handset able to use the cell phone number.

Another example of a secure user identifier can be a biometric identifier. For example, a real-time or immediate photo of the user captured by the mobile device can be used. For example, a photo taken at or near authentication time may be used. A fingerprint scan, retina scan, or another biometric measure can also be used.

A hardware device identifier can be retrieved from the mobile computing device, as in block 220. The hardware device identifier may be an embedded MEID (Mobile Equipment Identifier), IMEI (International Mobile Equipment Identity), Integrated Circuit Card ID (ICCID), or an ESN (Electronic Serial Number). A Mobile Equipment Identifier is an ID number that is globally unique for each CDMA (Code Division Multiple Access) mobile device in the world. This ID number can identify a phone to a cell phone network and can be used to flag stolen or lost phones. With 56 bits, MEID provides for 16 million times as many unique numbers as compared with the older ESN system. MEID support is included in CDMA phones and the CDMA networks support the use of MEIDs. MEID is equivalent to IMEI for GSM and WCDMA phones. MEID is also designed to be compatible with IMEI for phones that include both CDMA and GSM/W-CDMA (Global System for Mobile Communications/ Wideband Code Division Multiple Access) technology.

For example, with the Android operating system for mobile devices, the following information can be retrieved from the cell phone: phone number, MEID, and MAC address. On the Apple iOS operating system (iPhone, iPad and iPod), the MAC address and UDID (unique identifier found on all pieces of Apple equipment running the iOS) can be retrieved.

The hardware device identifier may also be a MAC (Media Access Control) address that is unique to the specific hardware. Each mobile device can have a MAC address and this may be a component of the identification for the device. Each mobile device may be capable of a Wi-Fi connection, Bluetooth connection, or a cellular internet connection, and such devices may have a network capable chip set with a unique MAC address. Similarly, wired devices may have a network interface card (MC) that includes its own MAC address.

Physical location coordinates can be identified for the mobile computing device, as in block 230. The physical location coordinates can be identified by using geolocation technologies for providing location coordinates. In one example, identifying the physical location coordinates can be performed by obtaining GPS (Global Positioning System) coordinates for the mobile computing device. In another example, the physical location coordinates can be identified by obtaining geographic location coordinates using the signal strength of wireless signals between multiple wireless cell phone towers. As a result, this technology can use one of the following ways of determining location: GPS, Wi-Fi connections, and 3 G/4G cellular connections. This invention can take advantage of any of these three systems in an effort to be as specific about the device's location as possible.

In another example, the application may disable itself completely or uninstall itself when no geolocation hardware or GPS device is present. This means that the device being used may be checked for the existence of geolocation hardware. If no such hardware exists, then the application may not install or be otherwise disabled.

The secure user identifier, hardware device identifier and the physical location can then be sent to a web server, as in block 240. For example, the phone number, the MAC address and physical coordinates of the device can be sent to a web server which will do a database lookup to determine whether to tell the app it is allowed to run or not.

Each application can also have its own different application specific ID. The application ID can be used to verify that a trusted application is making an authentication request to the web application and database. A hacker who does not have access to the application ID will not be able to make a valid request.

A further operation is enabling access to the web application based on the secure user identifier, a hardware device identifier, and correct physical location coordinates as defined by the web application, as in block 250. The operation of enabling access can include sending a verification message with each web application transaction and/or database transaction. The verification message can include a secure user identifier, a hardware device identifier (ID) and physical location coordinates.

The verification message can be sent to a web server in a HTTP header and/or a web address for a transaction with the web application. The verification message in the HTTP header may be sent via a SSL (Secure Sockets Layer) or another encryption web protocol. Sending two copies of the verification information in the HTTP header and query portion of the web address helps stop query line based hacking attacks. When the web server receives the request, the web server may extract the transmitted data from the URL (Universal Resource Locator) query line and HTTP headers. Both sets of information can be checked for existence and then data point(s) from the query line and HTTP header can be checked against one another to determine whether the data points are the same. If the data points are not the same then this may be an indication or query line tampering.

The verification described for each application transaction can take place without checking the user's full credentials each time a transaction takes place. This reduces the burden on the end user of entering the user name and password to use the application while the user is using the correct hardware in the designated location(s). In addition, the geolocation verification of this technology places a challenging burden on a hacker to be in the right geographic location when the application is being used and relieves some of the security burden on the users. The full credentials may be requested periodically as defined by the web application. For example, a full credential login may be used at the beginning of each calendar day, calendar week, or the beginning of another designated time period.

Using the combination of the secure user identifier (e.g., cell phone number), hardware identifier, and physical location, allows the web application to limit access to sensitive data to a specific geographical location and a specific mobile device. In an example, web application use can be limited to buildings in a specific geographic radius, and when the mobile device moves outside that radius or the designated buildings, then access to the entire web application is terminated. In another specific example, one portion or multiple parts of a web application can be deactivated if the secure user identifier, the hardware device identifier, or the physical location submitted for verification is incorrect. A flag may be used that can be set to deactivate the desired portions of the web application or the entire web application.

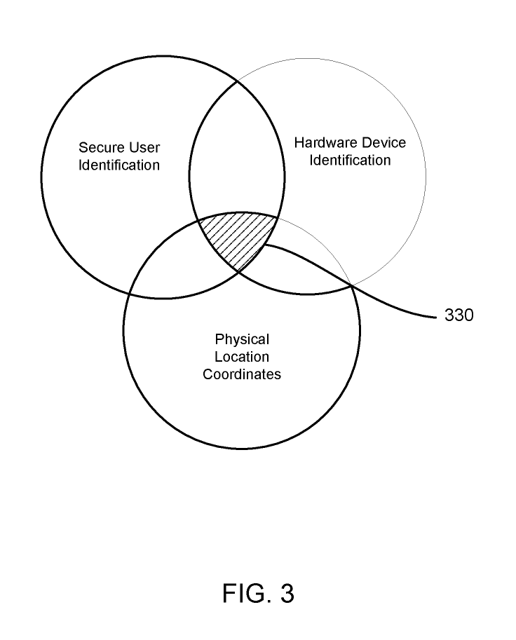

FIG. 3 is an example of a Venn diagram illustrating data types that can be used for mobile computer device security. The intersection of the multiple types of data described in this technology provides an information space that is more difficult for hackers to attack. The activation of the web application can also be limited by other work oriented criteria.

In the example of a hospital setting, the access to the web application can be further limited by retrieving unique information from a medical professional's ID card and the information encoded on the professional's ID card can be used as an additional element of authentication process described previously. For example, a medical professional can: 1) scan the bar code on their ID badge, 2) swipe the magnet strip on their ID badge, or 3) retrieve info from an RFID capable ID badge or separate badge made specifically for this purpose using RFID and/or NFC technology.

In another configuration of the web application, the web application will be enabled only when the mobile electronic device has a device level security access screen enabled. In smart phones, this device level security screen can be a PIN (Personal Identification Number) or a graphical security pattern (e.g., Android requests a pattern to be input) to unlock the phone. Similar methods can be used on other mobile computing devices.

In another example, a temporary location of a mobile computing device can be authenticated to provide access to the web application at the temporary location for a defined period of time after full login credentials have been provided by an end user. For example, a user may desire to use the application at a location outside of the authorized geographic area for the web application. In this case, the user can provide their full credentials to the web application and this may authorize the user in that new location for a limited period of time (e.g., one or two hours). At the end of that time period, the location may be de-authorized because the system expects that the user has moved on from the temporary location.

In addition to mobile devices, this technology can also be used for the connection of more stationary devices to a network like vending machines, medical monitoring equipment, environmental sensors, etc. This technology allows more stationary devices to be monitored to determine that they are in the location that the device is believed to be located at during operation. As more devices are connected to a geolocation device and the Internet, then verifying the location of a device along with receiving additional elements of authentication becomes more important and viable.

Since most mobile devices are a unique single user environment, this technology provides an opportunity to use a different authorization scheme that is less demanding on the user and at the same time maintains a high level of security. Additionally, access for mobile devices and web applications can be terminated by the central authentication authority or authorities upon notification by the mobile device owner. The design of the system is such that access or denial of access can be committed at the application, device, or user level.

This present technology can be used to identify stolen or lost hardware and determine where that hardware is located. When an individual who has obtained the stolen or lost hardware tries to execute or login to the web application, the geographic location or GPS coordinates of the hardware can be captured. This provides the opportunity to contact local police authorities in order to retrieve a lost or stolen device at a very specific geographic location.

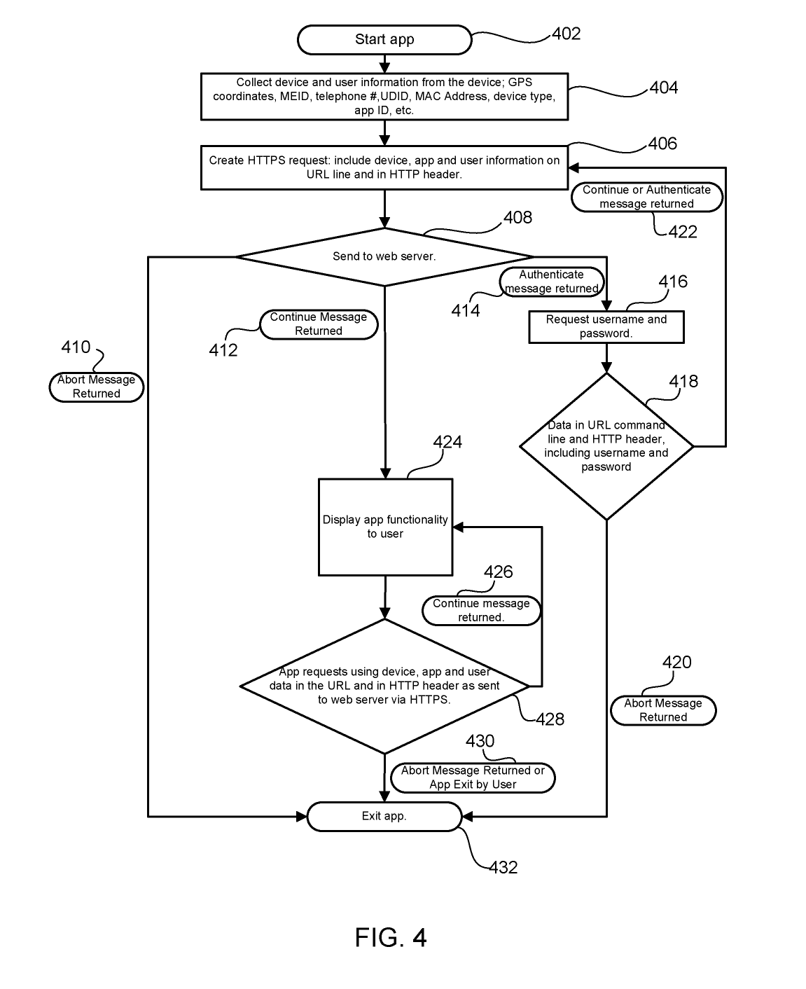

FIG. 4 is a flowchart illustrating an example of a method for providing web application security. The flowchart depicts a collection of device and user information that may be used in a URL and HTTP header. The device and user information may be sent to the web server, and if the information is validated, then the web application may display the web application functionality to the end user. In other words, access to the web application may be authenticated. In some situations, a full authentication may be desired and the user name and password can be collected.

For example, when a user starts an application 402, information about the user, device and application may be collected from the device 404. For instance, information that identifies the device may be collected and may include a cellular phone number, MEID, UDID, MAC address, device type, etc. An application ID may be collected as well as information about the geo-location of the device. Geo-location information may be obtained using satellite navigation equipment (e.g., GPS) contained in the device, wireless cell phone signals or other geo-location systems.

After collecting the information, an HTTPS (Hypertext Transfer Protocol over SSL (Secure Socket Layer)) request may be created 406 that may include the device, application and user information in a URL line and in an HTTP header. The information may be sent to a web server 408. The method may then determine whether the device and user information is valid, for example, by comparing the information received from the device (e.g., device identifier and application ID) with information stored in a data store or database. The method then may determine whether the geo-location of the device is within boundaries (e.g., longitude and latitude) defined for the application. Based upon the authentication results of the information sent by the device, a message may be returned from the method providing an instruction to the web server to abort 410 the application access request, continue 412 to the next portion of the method or to authenticate 414 the user by requesting a username and password 416.

In some cases, a full authentication may be desired by requesting a username and password 416 from the device user. For example, an initial ‘registration’ of the device may include a request for a username and password. Also, once the user may be recognized and the usage of the application may be certified, a request for a username and password may be made at random times, set times, or when a full authentication may be warranted (e.g., a device's geo-location does not match an expected geo-location). When a full authentication may be warranted, the method may return an authenticate message 414 to the device requesting a username and password 416. Upon entering a username and password, the username and password may be placed in a HTTP header and URL command line 418. A continue or authenticate message 422 may be returned and an HTTPS request that includes the initial login information with the username and password may be created 406 and sent to the web server 408. The HTTPS request may then be received by the web server for authentication. If the web server is unable to authenticate both the username and password in conjunction with the device and user information, an abort message 410 may be returned and the application may be exited 432.

Upon a successful authentication, the application functionality may be displayed 424 to the user of the device. The application may then request 428 the same user, device and application information that was sent to the web server for the initial login. In one example, the information may be supplied to the application from the HTTPS request received by the web server. In another example, the device may create a new HTTPS request that contains the information in the HTTP header and URL line and send the HTTPS request to the application via the web server. Upon receiving the information, the application then may return a continue message 426 that allows the user access to the application. If the application is unable to verify the information (e.g., an invalid application ID or secure user ID was supplied), an abort message 430 may be returned and the application may be exited 432.

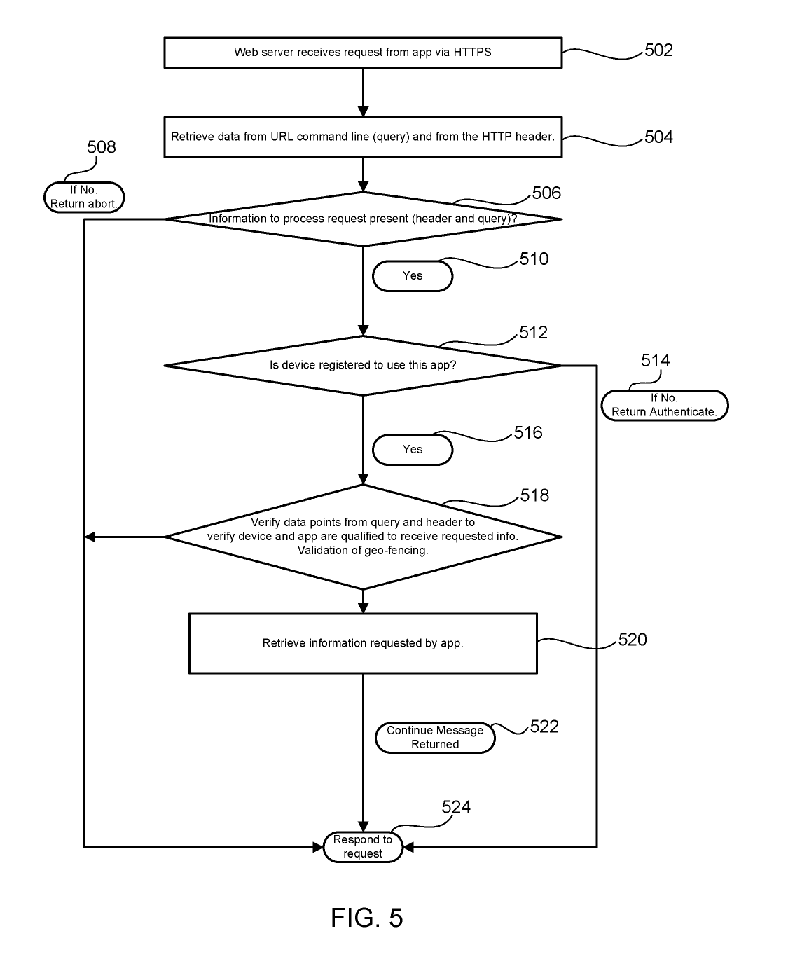

FIG. 5 is a flowchart illustrating an example of a method for web server application validation. The flowchart illustrates that a web application can check to see if the hardware device is registered to use a specific web application. Data points sent via the query in the URL and the HTTP headers may be used to validate the request, and then the appropriate information may be retrieved from a database, returned to the application and displayed to the end user.

For example, a web server may receive an HTTPS request 502 from a web application to validate a device. The web server may retrieve data 504 about the device from the HTTP header and URL query line. The data may be parsed or extracted from the HTTP header and URL query line by the web server to ensure that the data is present 506. If the data is not present (e.g., the device data is missing) then the web server may return an abort command 508 to the web application. If the data is found in the HTTP header and URL query line, then the web server may continue 510 to the next process.

The method then may determine whether the device is registered to use the web application 512. In order to determine whether the device is registered to use the web application, an identifier provided by a device may be used to validate the device. In one example, an application ID may be used to validate the device. For example, a web application executed on a web server may be assigned a unique application ID and this application ID may be stored on a device. A request from the web application may include the application ID obtained from the device. If the web server is unable to recognize the application ID sent by the device, the web server may return an authenticate request 514 to the requesting web application. In another example, an alternative type of device identifier may be used to verify that the device is registered to use the application. For instance, a phone number, MEID, Mac address, UDID, etc. may be sent to the web server, and the web server may compare the device identifier against a database of device identifiers. If the device identifier is not found, then the web server may send a return authenticate request 514 to the web application.

Upon successful validation 516 that the device is registered to use the application, the web server may perform a comparison 518 of data points extracted from the URL query and HTTP headers. Data points may come from verification information included in the URL query and HTTP headers and may include a secure user identifier, a hardware device identifier (ID) and physical location coordinates. The data points in the URL query and HTTP headers may be compared to ensure that the data points are the same. Comparing two copies of the verification information in the URL query and HTTP headers of the web address may help prevent query line based hacking attacks.

Validation of geo-fencing 518 may be performed by comparing physical location coordinates received from a device to a defined boundary for operation of the web application. The physical location coordinates may have been included in verification information extracted from the URL query and HTTP headers. Devices within the defined boundary (e.g., a certain building or group of buildings) may be granted access to the application. If the physical location coordinates of the device are outside of the defined boundary, the web server may respond to the device's application access request by returning an abort command 508. Upon a successful authentication of the device's physical location coordinates, the web application and/or web server may retrieve information requested by the application 520, return a continue message 522 and then respond to the web application's request 524 by affirming that the device is registered to use the specific web application.

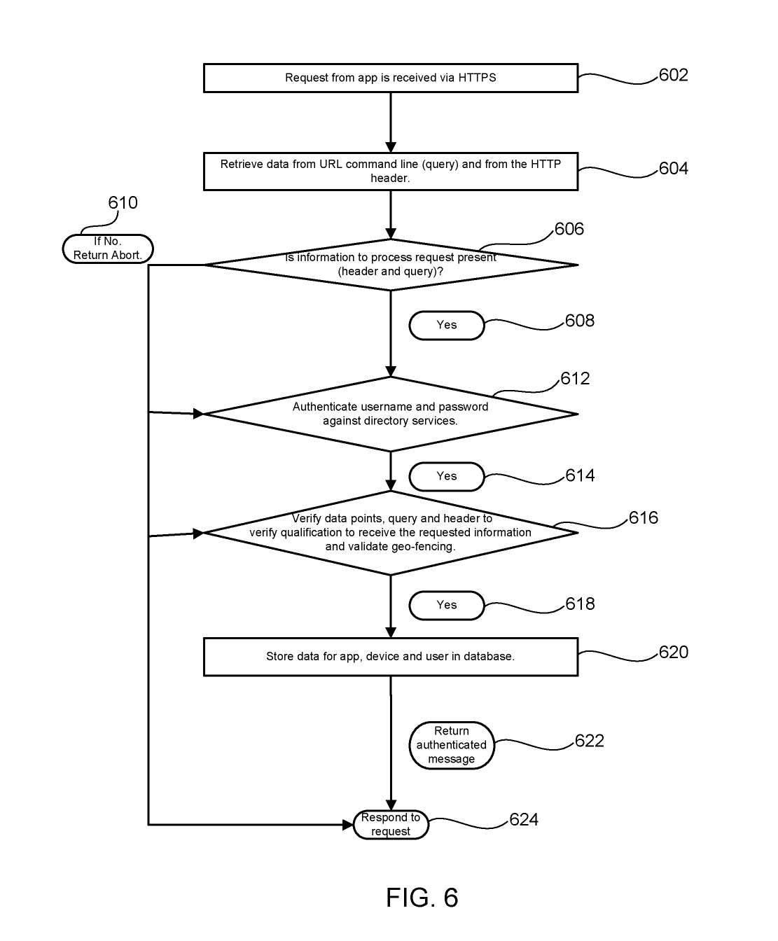

FIG. 6 is flowchart illustrating an example of a method for web server authentication. This method uses the information about the device and user and may request an authentication using a user name and password that can be authenticated against a database of user accounts or directory services. The information about the application, device and user can be stored in the database or similar repository and used to validate later requests. This method can also be used for initially authenticating a mobile computing device.

For example, a request from an application may be received by the web server via an HTTPS protocol 602. Data included in the request may include device and user information that may be parsed from an HTTP header and URL query line 604. Device information may include, for example, a device identifier (e.g., a secure user identifier) and device geo-location, and user information may include, for example, a username and password. The method may determine whether information to process the request is present in the HTTP header and URL query line 606. If the device and user information are not included in the HTTP header and URL query line, a command to abort 610 the method may be given by the web server. If the information is found in the HTTP header and URL query line, then a command to continue may be given 608. Authentication of the user's username and password 612 against a database of user accounts or a directory service may be performed. For instance, a user's username may be provided to a directory service that may act as a mapping service between usernames and passwords. The directory service may allow the lookup of a password based on a given username. If a password is returned by the directory service that matches the password provided by the user, then the command to continue 618 may be given. If a username does not exist in the directory service, or if the directory service is unable to validate the password the user provided, then the web server may respond by returning an abort command 610, thereby denying the device access to the application.

Upon validating the user's username and password, the web server may perform a comparison of data points 616 extracted from the URL query and HTTP headers. Data points may come from verification information included in the URL query and HTTP headers and may include a secure user identifier, a hardware device identifier (ID) and physical location coordinates. The data points in the URL query and HTTP headers may be compared to ensure that the data points are the same.

Physical location coordinates extracted from the URL query and HTTP headers sent by a device may be used to validate 616 that the device is within a defined boundary associated with a boundary of operation for the application. For instance, a boundary may be defined for a building, campus, city, or other area. A policy may be applied that those devices within the defined boundary may be granted access to the application while other devices may not be granted access. The physical location coordinates received from the device may be compared with the defined boundary to determine whether the physical location coordinates of the device are within the defined boundary. If the physical location coordinates of the device are outside of the defined boundary, the web server may respond to the device's application access request by returning an abort command 610. If the physical location coordinates of the device are within the defined boundary 618, then the method may store data for the application, device and user in a database 620. By storing the data, subsequent requests made by the device may not need to include certain data (e.g., username and password data or other portions of the authentication data). Upon a successful authentication, the method may respond 624 to the application access request by returning an authenticated message 622.

The technology described herein may describe a methodology that secures an application and associated information using a method of authentication. One factor of authentication may be information that a user may know, such as a password for example. A second factor of authentication may be combined with the first, such as information that a user has (e.g., a device code from the user's device). A third factor of authentication may be combined with the first and second factors, for example, information about the user, such as a biometric identifier (e.g., voice, hand configuration, fingerprint, retina scan, etc.). The examples described in this specification may have described methods that combine two or more factors for securing an application and associated information. As will be appreciated, any number of factors may be combined with the examples given and the examples give herein are merely representative and not limiting.

The term server or web server as used in this specification may include any computing device that may have the ability to run one or more services and communicate with one or more devices over a network by receiving a plurality of requests from a device and responding to a plurality of requests from a device. A server may include, but is not limited to, a server, application server, authentication server, content server, main frame server, database server, file server, gaming server, or some other kind of server. Any reference to a web application may also include a reference to an application that may communicate with a server for authentication via communication protocols other than web protocols (HTTP, etc.).

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method for allowing access to a web application using a mobile computing device, comprising:
obtaining a secure user identifier from the mobile computing device;
retrieving a hardware device identifier from the mobile computing device;
identifying physical location coordinates using the mobile computing device;
sending the user identification, hardware device identifier and the physical location to a web server; and
enabling access to the web application based on the secure user identifier, a hardware device identifier and correct physical location coordinates as defined by the web application.

2. The method as in claim 1, wherein a verification message, including a secure user identifier, a hardware device identifier and physical location coordinates, is sent to a web server in a HTTP header and a web address for a transaction with the web application.

3. The method as in claim 1, further comprising authenticating a temporary location of a mobile computing device to access the web application for a defined period of time after full login credentials have been provided by an end user.

4. The method as in claim 1, further comprising deactivating at least a portion of a web application if the secure user identifier, the hardware device identifier, or the physical location is incorrect.

5. The method as in claim 2, further comprising sending the verification message with each transaction from the web application.

6. The method as in claim 2, further comprising sending the verification message via a SSL (Secure Sockets Layer).

7. The method as in claim 1, wherein the secure user identifier is a unique cellular phone number.

8. The method as in claim 1, wherein hardware embedded device identifier is an MEID (Mobile Equipment Identifier), IMEI (International Mobile Equipment Identity), or an ESM (Electronic Serial Number).

9. The method as in claim 1, wherein identifying the physical location coordinates is performed by obtaining GPS (Global Positioning System) coordinates for the mobile computing device.

10. The method as in claim 1, wherein identifying the physical location coordinates is performed by obtaining geographic location coordinates using wireless signals.

11. The method as in claim 1, wherein the secure user identifier is a biometric identifier.

12. The method as in claim 1, further comprising using a scan of a medical patient's ID card to use as part of authentication.

13. The method as in claim 1, wherein obtaining a secure user identifier associated with the mobile computing device further comprises confirming the secure user identifier with an application server or a secure wireless network provider.

14. A system for allowing access to electronic information, the system comprising:
a mobile computing device having wireless communication capability, a hardware identifier, and a secure user identifier;
a wireless geolocation device in the mobile computing device to capture a geographic location of the mobile computing device; and
a web application client residing on the mobile computing device configured to send the secure user identifier, the hardware identifier and the geographic location to a web application to validate transaction requests with the web application.

15. The system as in claim 14, further comprising a web server with the web application in communication with the web application client.

16. The system as in claim 14, further comprising a database in communication with the web application and the database is configured to transmit data for the web application after the web application has validated the correct secure user identifier, hardware identifier and geographic location received from the web application client.

17. A method for allowing access to an application using a mobile computing device, comprising:
obtaining a secure user identifier associated with the mobile computing device;
identifying a hardware device identifier of the mobile computing device;
identifying physical location coordinates of the mobile computing device;
sending the user identification, hardware device identifier and the physical location to a server; and
enabling access to the application based on the secure user identifier, a hardware device identifier and correct physical location coordinates as defined by the application and as validated by the server.

18. The method of claim 17, wherein the secure user identifier further comprises a unique cellular phone number or UDID (Unique Device Identifier).

19. The method as in claim 17, further comprising authenticating a temporary location of a mobile computing device to access the application for a defined period of time after full login credentials have been provided by an end user.

20. The method as in claim 17, further comprising deactivating the application if the secure user identifier, the hardware device identifier, or the physical location is incorrect.
